(19) United States
(12) Patent Application Publication
(10) Pub. No.: US 2016/0239192 A1
(43) Pub. Date: Aug. 18, 2016

(54) SYSTEM AND METHOD OF ENTERPRISE INSTANT MESSAGE

(71) Applicant: MITAKE INFORMATION CORPORATION, Taipei City (TW)

(72) Inventor: Hung-Che CHIU, Taipei City (TW)

(21) Appl. No.: 14/753,135

(22) Filed: Jun. 29, 2015

(30) Foreign Application Priority Data
Feb. 12, 2015 (TW) 104104681

(51) Int. Cl. G06F 3/0484; H04L 12/58; G06F 3/0482

(52) U.S. Cl. CPC G06F 3/04847; G06F 3/0482; G06F 3/04842; H04L 51/04

(57) ABSTRACT

A system and method of an enterprise instant message are provided. The system includes a database and a server. The database stores a first and a second timeline and member information sets. The server receives a merging instruction, a separating instruction, a closing instruction, and a switching on instruction to configure a timeline parameter, receives an uploaded message including an attribute, writes the message to the first and second timeline when the attribute matches the first and second timeline, respectively, receives a first and a second timeline download instructions and reads from the database downloadable messages of the first and second timeline, respectively, receives a merging timeline download instruction and reads from the database downloadable messages of the first and second timeline, and manages menu items of a menu bar and generates a menu item sequence according to the quantity of menu items displayed and the timeline parameter.

### BACKGROUND OF THE INVENTION

1. Field of the Invention

The present invention relates to cloud technology applicable to mobile communication devices, and more particularly, to a system and method of an enterprise instant message.

2. Description of the Prior Art

Due to the rapid popularization of smartphones, more and more enterprises use cloud technology on smartphones for exchanging enterprise internal messages. However, the prior art still has many drawbacks to meet the needs for corporate governance.

Citation 1 is directed to providing message exchange service within a single level organization by a cloud, a mobile communication device, and push technology, for example, “Line” application developed by Japan-based LINE Corporation, a subsidiary of South Korea-based NHN, and “group timeline” functions provided by a back-end system of the “Line” application. The technical problem to be solved by citation 1 is as follows: there is only one piece of group timeline and thus impossible to distinguish a private purpose and a public purpose from each other. That is to say, when the group timeline of citation 1 is used in corporate governance, members post all articles, whether workplace documents (pertaining to work) or personal documents (not pertaining to work), in the same group timeline without distinguishing a private purpose and a public purpose from each other, thereby leading to spamming, which is known as “page cleaning” and “board cleaning” in Taiwan and known as “screen scrubbing” and “screen cleaning” in China. For instance, after a specific member posts a work-related article (“workplace document” for short) such as a company's announcement, another member posts multiple fun articles not pertaining to work (“personal documents” for short). In this situation, the workplace document is overwhelmed, and thereby rendered imperceptible, by the personal documents. In this regard, the technical problem to be solved by citation 1 is as follows: conventional person-to-person real-time message systems are useless to a group or a company. The technical effect produced by citation 1 is as follows: a single level organization shares messages by fixed single group timeline.

Citation 2, such as Facebook, enables messages to be exchanged between a computer and a mobile communication device by cloud technology. According to citation 2, the exchange of group message occurs in four ways, namely Facebook, Facebook Page, Facebook Groups, and Facebook at Work. However, like citation 1, citation 2 merely provides fixed single timeline for use in all the aforesaid ways of carrying out the exchange of group message. That is to say, like citation 1, citation 2 is confronted with a problem, that is, failure to distinguish a private purpose and a public purpose from each other. In the case of citation 2, it is necessary to provide different accounts or groups in order to distinguish a private purpose and a public purpose from each other, for example, posting workplace documents in Facebook at Work, and posting personal documents in Facebook. The technical problem to be solved by citation 2 is as follows: conventional social networking technology is restrictive of connections development and friend making. The technical effect produced by citation 2 is as follows: providing a solution adapted for use in four different scenarios and characterized in that a single level organization shares messages by fixed single timeline.

Neither of the aforesaid citations discloses a timeline management module for carrying out timeline management to serve a private purpose and a public purpose. For example, where multiple different companies share the same cloud-based real-time message system, some companies only allow members to post work-related messages in timeline, whereas some other companies allow members to post both private messages and public messages as long as the messages are managed with two different pieces of timeline, respectively. Neither citation 1 nor citation 2 discloses a timeline management module for flexibly adjusting the quantity of timeline and flexibly allowing companies to choose “private timeline and public timeline”, “merging private timeline and public timeline to become one timeline” or “closing personal documents timeline but permitting workplace document timeline”. Therefore, it is necessary to provide an enterprise instant message system and method for use in corporate governance and thus enable companies to manage timeline flexibly as needed, thereby overcoming the drawbacks of the prior art.

### SUMMARY OF THE INVENTION

In view of the aforesaid drawbacks of the prior art, the present invention provides a system and method of an enterprise instant message to flexibly adjust the quantity of timeline.

The present invention provides a system of an enterprise instant message, comprising: a database and a server at a server end, and a mobile communication device at a client end, wherein the database and the server together form a cloud. The database stores a first timeline, a second timeline and a plurality of member information sets. The first timeline has a first ID. The second timeline has a second ID. The member information sets each comprise an account and a password. The server accesses the database and comprises a first network communication module for establishing a network connection with a mobile communication device associated with one of the member information sets; a login verification module for verifying whether the mobile communication device connects with the server through a network and for receiving the account and the password uploaded through a network connection so as to undergo verification; a timeline management module for receiving a merging instruction, a separating instruction, a closing instruction and a switching on instruction which are uploaded to configure a timeline parameter; a first message module for receiving at least one message uploaded by the mobile communication device or a message entering module, wherein the at least one message each comprises an attribute, to write (i.e., store) the message to the first timeline of the database when the attribute corresponds to the first timeline, and write the message to the second timeline of the database when the attribute corresponds to the second timeline, thereby allowing the first message module to write the message to the first timeline or the second timeline in accordance with the attribute; an information filtering module for responding to or receiving a first timeline download instruction and reading the message related to the first timeline from the database to provide download, for responding to or receiving a second timeline download instruction and reading the message related to the second timeline from the database to provide download, for responding to or receiving a merging timeline download instruction and reading the message related to the first and second timeline from the database to provide download, and for automatically sending one of the message related to the first timeline and the message related to the second timeline to the mobile communication device, wherein the database and the server together form a cloud; and a first menu adjustment module for managing a plurality of menu items of a menu bar and generating a menu item sequence in accordance with quantity of menu items displayed and a timeline parameter.

The mobile communication device has a screen and executes an application. The application comprises: a second network communication module for establishing a network connection with the first network communication module of the server; a login module for receiving the account and the password entered and uploading the account and the password to the server through the second network communication module; a data access module for generating and uploading the first timeline download instruction, the second timeline download instruction, and the merging timeline download instruction in accordance with the current view and then downloads a related message from the server; a second menu adjustment module for displaying a plurality of menu items concerned on a menu bar in accordance with a menu item sequence downloaded, wherein the menu bar is displayed on a screen; a second message module for displaying a summary of the downloaded message in the view of the screen and receiving a selection instruction of the summary to display the complete contents of the message in the view of the screen; and a message entering module for entering the message, configuring the attribute of the message, and uploading the message to the server through the second network communication module.

The mobile communication device further comprises one or more processors and a screen. The one or more processors execute a plurality of program instructions. The program instructions comprise a first program instruction, a second program instruction, a third program instruction, a fourth program instruction, and a fifth program instruction. The first program instruction instructs the mobile communication device to establish a network connection with the server so as to undergo login verification. The second program instruction instructs the mobile communication device to upload the first timeline download instruction, the second timeline download instruction, and the merging timeline download instruction to the server and then download a related message from the server. The third program instruction instructs the mobile communication device to display a summary of the message in a view of the screen and receive a selection instruction of the summary to display the complete contents of the message in the view. The fourth program instruction instructs the mobile communication device to receive the message entered, configure the attribute of the message, and upload the message to the server. The fifth program instruction instructs the mobile communication device to display a plurality of menu items concerned on a menu bar in accordance with a menu item sequence downloaded from the server, with the menu bar displayed on the screen.

The present invention provides a method of an enterprise instant message, applicable to a cloud comprising a database and a server, the method comprising the steps of: storing a first timeline, a second timeline, and a plurality of member information sets in the database, wherein the first timeline has a first ID, and the second timeline has a second ID, with the member information sets each comprising an account and a password; establishing a network connection between the server and a mobile communication device associated with one of the member information sets so as to undergo login verification, wherein the server receives the account and the password uploaded from the first mobile communication device so as to undergo login verification; receiving by the server a merging instruction, a separating instruction, a closing instruction, and a switching on instruction uploaded from the first mobile communication device to configure a timeline parameter, wherein the merging instruction causes the timeline parameter to be configured to merge the first timeline and the second timeline, the separating instruction causes the timeline parameter to be configured to separate the first timeline and the second timeline, the closing instruction causes the timeline parameter to be configured to close the second timeline, and the switching on instruction causes the timeline parameter to be configured to switch on the second timeline; wherein the server manages a plurality of menu items of a menu bar and generates a menu item sequence in accordance with the quantity of the menu items displayed and the timeline parameter. The server establishes a network connection with a second mobile communication device associated with one of the member information sets. The server receives the account and the password uploaded from the second mobile communication device so as to undergo verification. The server receives at least one message uploaded from the second mobile communication device, wherein the message comprises an attribute. The server writes the message to the first timeline of the database when the attribute corresponds to the first timeline, and writes the message to the second timeline of the database when the attribute corresponds to the second timeline, thereby writing the message to the first timeline or the second timeline in accordance with the attribute. The server responds to or receives a first timeline download instruction uploaded from the second mobile communication device and reads the message related to the first timeline from the database to provide download, responds to or receives a second timeline download instruction and reads the message related to the second timeline from the database to provide download, responds to or receives a merging timeline download instruction and reads the messages related to the first and second timeline from the database to provide download, respectively, and automatically sends the message of the first timeline and/or the message of the second timeline to the mobile communication device.

The present invention provides a method of an enterprise instant message, applicable to a cloud comprising a database and a server, and applicable to a mobile communication device for accessing a cloud, the cloud comprising a database and a server, the database storing therein a first timeline, a second timeline, and a plurality of member information sets. The first timeline has a first ID. The second timeline has a second ID. The member information sets each comprises an account and a password. The mobile communication device is associated with one of the member information sets, comprises a screen, and executes an application to implement the method. The method comprises the steps of: establishing a network connection with the server, receiving the account and the password entered, and uploading the account and the password to the server so as to undergo login verification; displaying a plurality of menu items concerned on a menu bar in accordance with a menu item sequence downloaded and displaying the menu bar on the screen; receiving a message entered, configuring an attribute of the message, and uploading the message to the server; generating and uploading the first timeline download instruction, the second timeline download instruction and the merging timeline download instruction in accordance with a view of the screen; downloading the related message from the server and displaying a summary of the downloaded message in the view of the screen; and receiving a selection instruction of the summary to display the complete contents of the message in the view of the screen.

The present invention provides a system of an enterprise instant message, comprising: a database for storing timeline and a plurality of member information sets, wherein the member information sets each comprises an account; and a server for accessing the database, comprising: a first network communication module for establishing a network connection with a mobile communication device associated with one of the member information sets; a login verification module for verifying whether the mobile communication device logs in to the server with the account through a network and connects with the server through the network; a first message module for receiving at least one message uploaded by the mobile communication device and writing the at least one message to the timeline of the database, wherein the at least one message each comprises an attribute; and an information filtering module for responding to a timeline download instruction associated with the attribute, reading the message related to the timeline from the database, associated with the attribute, to provide download to the mobile communication device, and automatically sending the message of the first timeline and/or the message of the second timeline to the mobile communication device, wherein the database and the server together form a cloud.

The present invention provides a method of an enterprise instant message, applicable to a cloud comprising a database and a server, the method comprising the steps of: storing timeline and a plurality of member information sets in the database, the member information sets each comprising an account; establishing a network connection between the server and a mobile communication device associated with one of the member information sets to undergo login verification by the account; receiving at least one message uploaded from the mobile communication device and writing the at least one message to the timeline by the server, the at least one message each comprising an attribute; and responding to a timeline download instruction associated with the attribute, reading the message related to the timeline from the database, associated with the attribute, to provide download to the mobile communication device, and automatically sending the message of the first timeline and/or the message of the second timeline to the mobile communication device, by the server.

The embodiments below describe the features and advantages of the present invention in detail, and its contents is sufficient to allow any person skilled in the art to understand the technical contents of the present invention and implement it accordingly. The disclosure of the specification, claims, and drawings enable any person skilled in the art to understand the objectives and advantages of the present invention easily.

### BRIEF DESCRIPTION OF THE DRAWINGS

FIG. 1 is a schematic view of the system architecture according to an embodiment of the present invention;

FIG. 2 is the schematic view 1 of a mobile communication device according to an embodiment of the present invention;

FIG. 3 is the schematic view 2 of the mobile communication device according to an embodiment of the present invention;

FIG. 4 is the schematic view 3 of the mobile communication device according to an embodiment of the present invention;

FIG. 5 is the schematic view 4 of the mobile communication device according to an embodiment of the present invention;

FIG. 6 is the schematic view 5 of the mobile communication device according to an embodiment of the present invention;

FIG. 7A is the schematic view 6 of the mobile communication device according to an embodiment of the present invention;

FIG. 7B is the schematic view 7 of the mobile communication device according to an embodiment of the present invention; and

FIG. 8 is a flowchart of a method according to an embodiment of the present invention.

### DETAILED DESCRIPTION OF THE EMBODIMENTS

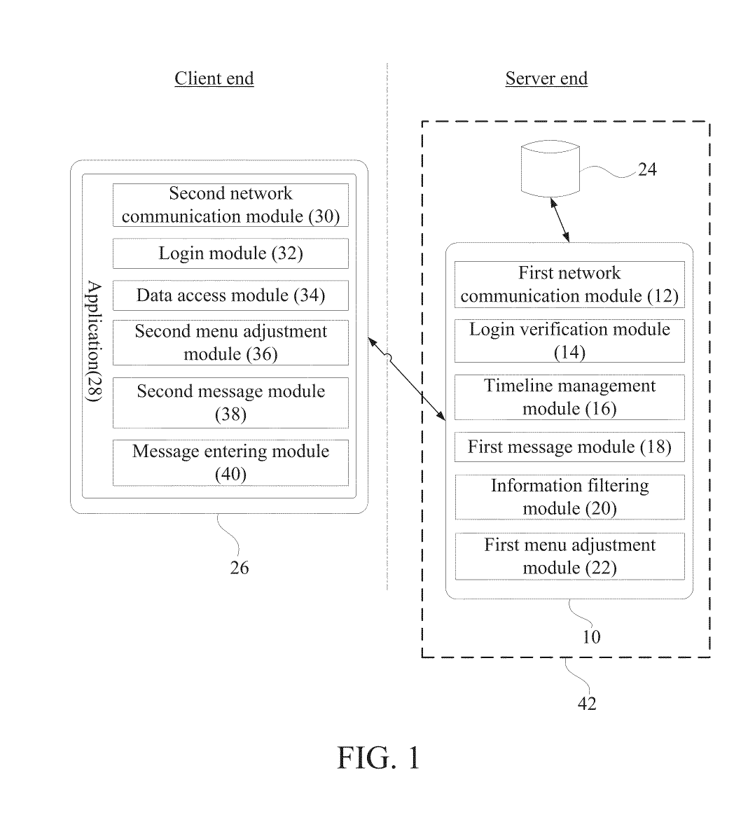

Referring to FIG. 1, there is shown a schematic view of the system architecture according to an embodiment of the present invention. The system of the present invention comprises a database 24 and a server 10 at a server end (i.e., a cloud 42), and a mobile communication device 26 at a client end. The database 24 stores therein first timeline, second timeline, and a plurality of member information sets. The timeline is also known as news feed or live feed. The timeline comprises a plurality of messages. The messages are in the formats of text, video/audio, image, file, URL, e-voting & questionnaire, check-in & location report, etc. The present invention is characterized in that: two independent pieces of timelines store and manage messages which serve two different purposes, namely workplace documents (pertaining to work) and personal documents (not pertaining to work). The first timeline stores workplace document messages pertaining to work, for example, a company's personnel announcement message, a customer project message, an employee attendance message, and a person/vehicle despatch message. The second timeline stores personal document message not pertaining to work, for example, a fun message, a gourmet message, a leisure message, and a personal video message. Each piece of timeline has a unique ID. The first timeline has a first ID, whereas the second timeline has a second ID. The member information sets each comprises an account and a password.

In this embodiment of the present invention, the server 10 comprises one or more processors and implements by means of coordinated operation of hardware and software the following modules: a first network communication module 12, a login verification module 14, a timeline management module 16, a first message module 18, an information filtering module 20, and a first menu adjustment module 22. The first network communication module 12 establishes a network connection with a second network communication module 30 associated with the mobile communication device 26 at the client end. In various embodiments of the present invention, the network connection complies with TCP protocol (including Socket and WebSocket Connection), HTTP protocol, or HTTPS protocol. The login verification module 14 receives an account and a password uploaded by a specific member through the mobile communication device 26 to verify whether the mobile communication device 26 connects with the server 10 through a network and then compare the account and the password with the accounts and the passwords stored in the database 24 and related to the member information sets. A timeline parameter is for use in receiving and configuring through the timeline management module 16 a merging instruction, a separating instruction, a closing instruction or a switching on instruction uploaded by a mobile communication device of an administrator. The instructions are usually uploaded in the first place when an administrator with authority configures the account of the organization. The merging instruction configures the timeline parameter to “merge the first timeline and the second timeline”. The merger does not entail merging messages related to the first timeline and the second timeline stored in the database 24 but entails “providing messages of the first timeline and the second timeline by the server 10 while data is being downloaded at the client end”. The purpose of the merger is to display workplace document messages and personal document messages in the same view (i.e., an application (App) 28 shows that only one timeline is available) while a user is browsing messages on the mobile communication device 26, and, at this point in time, only one timeline menu item together with other functions' menu items are shown on a menu bar of the application 28. The separating instruction configures the timeline parameter to “separate the first timeline and the second timeline” such that, when the timeline parameter is already configured to “merge the first timeline and the second timeline”, the separating instruction enables workplace document messages and personal document messages on the mobile communication device 26 to be displayed in two different views, respectively, that is, displaying the workplace document messages in the view of the first timeline and displaying the personal document messages in the view of the second timeline, and, at this point in time, the menu bar of the application 28 shows two timeline menu items and menu items of other functions. The closing instruction configures the timeline parameter to “close the second timeline”. In an embodiment of the present invention, general members (i.e., not restricted to an administrator with authority) upload the closing instruction, and the purpose of the closing instruction is to stop the second timeline message from being downloaded; hence, when workplace document messages and personal document messages are displayed in two views (the view of the first timeline and the view of the second timeline), respectively, the user who is not interested in any personal document messages not pertaining to work can opt to close personal documents, and, at this point in time, the menu bar of the application 28 only shows the first timeline menu item together with other functions' menu items. The switching on instruction configures the timeline parameter to “switch on the second timeline” such that, when the timeline parameter is already configured to “close the second timeline”, the switching on instruction switches on the second timeline; hence, the switching on instruction actually reconfigures the timeline parameter to “separate the first timeline and the second timeline” such that the menu bar of the application 28 shows two timeline menu items and menu items of other functions. The first timeline relates to corporate workplace document messages and thus cannot be closed with the closing instruction. The first message module 18 receives at least one message uploaded by a message entering module 40 of the mobile communication device 26, and the at least one message each comprises an attribute. The attribute is configured manually or automatically configured in accordance with the current view according to the function of the at least one message. If the attribute corresponds to the first ID of the first timeline, the first message module 18 writes the at least one message to the first timeline of the database 24 by treating the first ID as the attribute. If the attribute corresponds to the second ID of the second timeline, the first message module 18 writes the at least one message to the second timeline of the database 24 by treating the second ID as the attribute. The attribute of the at least one message is selected from a plurality of functions listed on a menu (i.e., a pull-down menu), wherein some of the functions are associated with the first ID, and the other functions are associated with the second ID. The information filtering module 20 performs the following: responding to the first timeline download instruction uploaded by the mobile communication device 26 and reading the messages related to the first timeline from the database 24 to provide download; responding to the second timeline download instruction and reading the messages related to the second timeline from the database 24 to provide download; and responding to the merging timeline download instruction and reading the messages related to the first and second timeline from the database 24 to provide download. The timeline management module 16 receives the merging instruction or the separating instruction uploaded from the mobile communication device 26 of an administrator to configure the timeline parameter such that the information filtering module 20 allows messages to be downloaded from the merged or separated first and a second timeline to the mobile communication device 26 associated with one of the member information sets. The first menu adjustment module 22 manages a plurality of menu items of the menu bar and generates a menu item sequence according to the quantity of menu items displayed and the timeline parameter. The quantity of menu items displayed is a system-predetermined value for configuring the number of menu items displayed on the menu bar of the application 28, for example, “4” indicates that there are four menu items on the menu bar. As mentioned before, the quantity of the menu items representative of timeline depends on the timeline parameter. When the timeline parameter is configured to “merge the first timeline and the second timeline” or “close the second timeline”, at this point in time, it indicates that there is only one menu item of timeline; as a result, in order to provide four menu items on the menu bar, the first menu adjustment module 22 automatically fill the vacancy of the menu bar with the fifth arranged menu item and generates a “menu item sequence”. For example, if the system default presets the menu item sequence to include the first timeline (indicative of workplace documents), the second timeline (indicative of personal documents), a chat room, a member list, a system configuration, and an invitation, wherein the menu items displayed are in the number of four. When the timeline parameter is configured to “merge the first timeline and the second timeline”, the menu item sequence generated by the first menu adjustment module 22 includes timeline (indicative of workplace documents and personal documents), a chat room, a member list, and a system configuration. When the timeline parameter is configured to “close the second timeline”, the menu item sequence generated by the first menu adjustment module 22 includes the first timeline (indicative of workplace documents), a chat room, a member list, and a system configuration. When the timeline parameter is configured to “separate the first timeline and the second timeline”, the menu item sequence generated by the first menu adjustment module 22 includes the first timeline (indicative of workplace documents), the second timeline (indicative of personal documents), a chat room, and a member list. The mobile communication device 26, which uploads messages, the first timeline download instruction, the second timeline download instruction, the merging timeline download instruction, the closing instruction, and the switching on instruction, is associated with one of the member information sets.

In various embodiments of the present invention, the aforesaid modules of the server 10 are regarded as resources for use in the coordinated operation of hardware and software, and the technical features of each module are expressed by a plurality of program instructions or part of an application, but the technical effect of each module must be achieved through the execution of the program instructions or the application (i.e., resources for use in the coordinated operation of hardware and software) by at least one processor. Related problems are solved by the present invention through the resources for use in the coordinated operation of hardware and software.

The present invention does not put any limit on the number of apparatuses on which the server 10 and the database 24 are disposed. In various embodiments of the present invention, the server 10 and the database 24 are disposed on the same apparatus. Alternatively, the server 10 and the database 24 are disposed on cluster-structured apparatuses, respectively, or on differently located cluster-structured apparatuses, respectively.

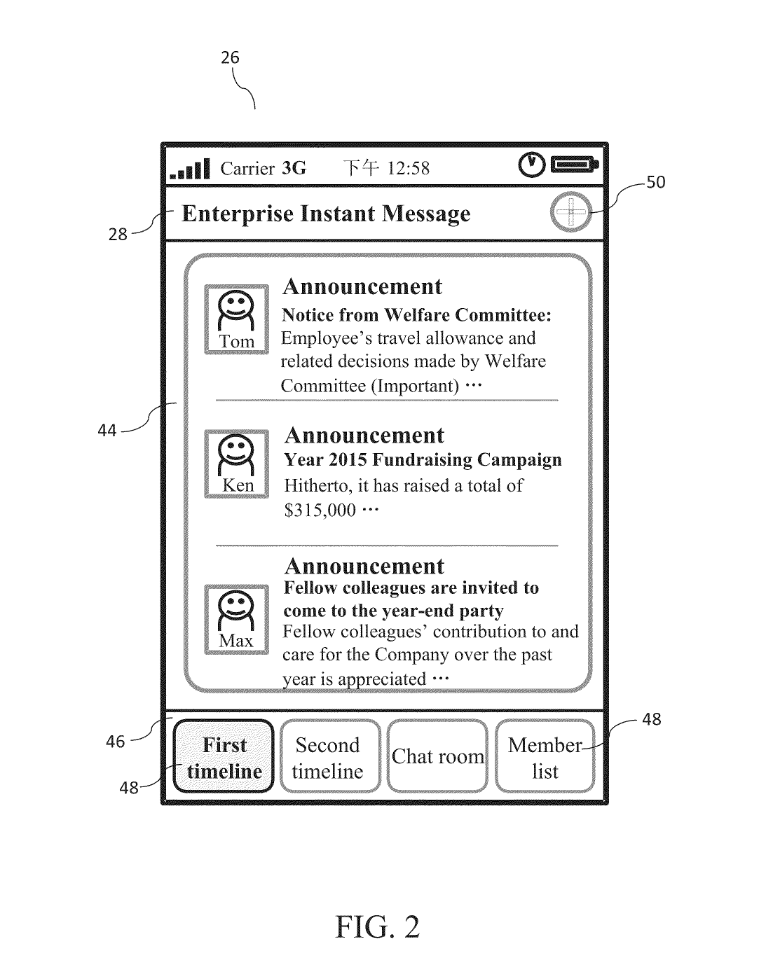

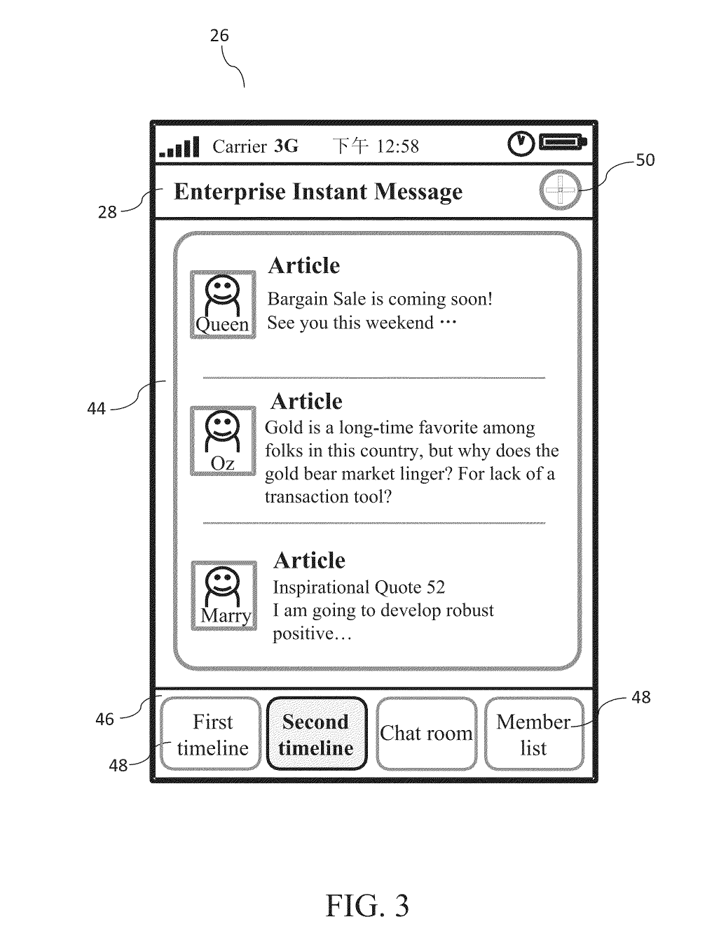

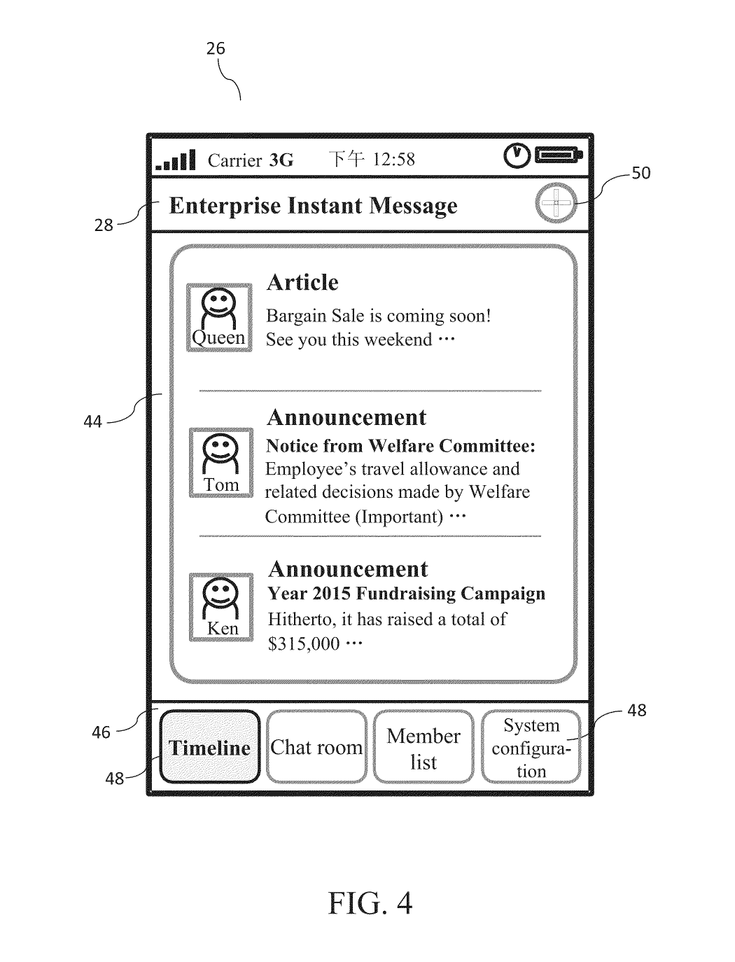

In various embodiments of the present invention, the mobile communication device 26 is a smartphone or tablet running on iOS, Android or Windows Phone operating system. The mobile communication device 26 comprises one or more processors. The one or more processors execute a plurality of program instructions or the application 28. The resources for use in executing the application 28 by the one or more processors comprise the second network communication module 30, a login module 32, data access module 34, second menu adjustment module 36, second message module 38, and the message entering module 40. The second network communication module 30 establishes a network connection with the first network communication module 12 of the server 10. In various embodiments of the present invention, the network connection complies with TCP protocol, HTTP protocol, or HTTPS protocol. The login module 32 receives the account and the password entered by the user (i.e., a member) through the entering interface of the mobile communication device 26 and uploads them to the server 10 for verification. In another embodiment of the present invention, the account and the password are buffered in a memory of the mobile communication device 26 such that, within a specific period of (say, a day or a week), the user can effectuate every instance of login automatically, without entering the account and the password manually. The data access module 34 generates and uploads the first timeline download instruction, the second timeline download instruction, and the merging timeline download instruction in accordance with the current view and then downloads a related message from the server 10. The current view is defined as the view at which the user currently generates a download instruction, such as a pull-down screen for updating data (i.e., “pull to refresh”). If the currently generated download instruction is intended for a view of the first timeline (i.e., a view for displaying workplace document messages only, as shown in FIG. 2), it will be necessary to generate the first timeline download instruction and download from the server 10 a related message, that is, a message of the first timeline. Referring to FIG. 2, the contents of a view 44 of the first timeline are updated as soon as a related message is downloaded. If the currently generated download instruction is intended for a view of the second timeline (i.e., a view for displaying personal document messages only, as shown in FIG. 3), it will be necessary to generate the second timeline download instruction and download from the server 10 a related message, that is, a message of the second timeline. Referring to FIG. 3, the contents of the view 44 of the second timeline are updated as soon as a related message is downloaded. If the currently generated download instruction is intended for a view of merging timeline (i.e., a view for displaying a workplace document message and a personal document message simultaneously, as shown in FIG. 4), it will be necessary to generate the merging timeline download instruction and download from the server 10 a related message, that is, a message of the first timeline and a message of the second timeline. Referring to FIG. 4, the contents of the view 44 of timeline are updated as soon as a related message is downloaded.

In another embodiment of the present invention, by selecting the first timeline/the second timeline/the timeline menu item 48 of a menu bar 46 shown in FIG. 2 through FIG. 4, not only the current view is changed, but also the first timeline download instruction, the second timeline download instruction or the merging timeline download instruction is generated. In addition, all the embodiments of the present invention can also be implemented by automatically polling. For example, the application 28 automatically generates a download instruction and sends the download instruction to the server 10 in real time or at a fixed time interval such that the information filtering module 20 of the server 10 responds to the first timeline download instruction, the second timeline download instruction and/or the merging timeline download instruction and reads the messages related to the first and second timeline from the database 24 to provide download to the mobile communication device 26.

In another embodiment of the present invention, the network connection downloads a related message by Socket or WebSocket connection such that the server 10 which has a new message does not require any download instruction which originates from the mobile communication device 26 and thus is capable of sending the new message directly to the mobile communication device 26 so as to form an expeditious channel disposed between the server 10 and the mobile communication device 26 and intended to deliver messages in real time.

A second menu adjustment module 36 displays a plurality of menu items concerned on a menu bar in accordance with a “menu item sequence” downloaded, wherein the menu bar is displayed on a screen. The second message module 38 displays a summary of the downloaded message in the view of the screen and receives a selection instruction of the summary to display the complete contents of the message in the view of the screen. The message entering module 40 enters the message, configures the attribute of the message, and uploads the message to the server 10 through the second network communication module 30. In an embodiment of the present invention, the attribute of the message is configured automatically by triggering the view (i.e., the current view) which the message is to be entered in accordance with the configuration attribute. For example, the second message module 38 automatically configures the attribute to the first timeline as soon as the user triggers entering a message (by pressing a “create new message button 50”, for example) in the view of the first timeline, and the second message module 38 automatically configures the attribute to the second timeline as soon as the user triggers entering a message in the view of the second timeline. In an embodiment of the present invention, a workplace document and a personal document are distinguished from each other according to the functions of the message, such as “announcement”, “reporting a case”, “assigning a task”, “check-in”, “position locating”, “voting”, “uploading a file”, and “article”. In this regard, “announcement”, “reporting a case”, “assigning a task”, “check-in”, “position locating”, “voting”, and “uploading a file” are attributed to workplace document messages, whereas “article” is attributed to personal document messages. The second message module 38 automatically configures the attribute according to the function(s) selected by the user as soon as the user triggers entering the message in the view of merging timeline. In an embodiment of the present invention, the attribute of messages is configured by the user manually, for example, the option “workplace documents” or the option “personal documents” is provided by a pull-down menu or a radio button. Hence, even if the application 28 shows the view of merging timeline (i.e., not distinguishing a workplace document and a personal document from each other), in the database 24, uploaded messages are stored in the first timeline and the second timeline according to the attribute of the uploaded messages to allow the administrator to upload the separating instruction for displaying the messages of the first timeline and the messages of the second timeline at the application 28, respectively.

According to the present invention, the mobile communication device 26 which accesses the cloud 42 comprises one or more processors and a screen. The one or more processors execute the application 28. The application 28 has a plurality of program instructions. The program instructions comprise a first program instruction, a second program instruction, a third program instruction, a fourth program instruction, and a fifth program instruction. The first program instruction instructs the mobile communication device 26 to establish a network connection with the server 10 so as to undergo login verification. The second program instruction instructs the mobile communication device 26 to upload the first timeline download instruction, the second timeline download instruction, and the merging timeline download instruction to the server 10 and then download a related message from the server 10. The third program instruction instructs the mobile communication device 26 to display a summary of the message in a view of the screen and receive a selection instruction of the summary to display the complete contents of the message in the view. The fourth program instruction instructs the mobile communication device 26 to receive the message entered, configure the attribute of the message, and upload the message to the server 10. The fifth program instruction instructs the mobile communication device 26 to display a plurality of menu items concerned on a menu bar in accordance with a menu item sequence downloaded from the server 10, with the menu bar displayed on the screen.

In various embodiments of the present invention, the first through fourth program instructions executed by the one or more processors are illustrative of a plurality of program instructions of the present invention rather than restrictive of their respective technical features or respective steps of the process flow of the method of the present invention. Persons skilled in the art understand that the respective technical features or respective steps of the process flow of the method with respect to the first through fourth program instructions can be combined in a manner to be expressed by different combinations of program instructions.

Referring to FIG. 2 through FIG. 6, there are shown schematic views of frames on the screen of the mobile communication device 26 according to an embodiment of the present invention. FIG. 2 shows that a first timeline and a second timeline (i.e., a timeline parameter configured to “separate the first timeline and the second timeline”) coexist in an embodiment of the present invention, and thus the menu items 48 of the first timeline (workplace documents) and the second timeline (personal documents) coexist on the menu bar 46, wherein the menu item sequence generated by the first menu adjustment module 22 includes the first timeline, the second timeline, a chat room, and a member list. The view 44 shown on the screen corresponds to the view 44 of the first timeline (and thus the menu item 48 of the first timeline is highlighted in white in the diagram). The view 44 displays a summary of a work-related workplace document message, and the user may select the summary in order to read the contents of the message. The user may select the create new message button 50 shown at the upper right corner of the diagram in order to enter a new message. Referring to FIG. 2, in an embodiment of the present invention, if the user selects the create new message button 50 (i.e., to trigger entering a message) in the current view 44 (i.e., the view of the first timeline), the attribute of the message is automatically configured to correspond to the current view 44 (i.e., the first timeline as shown in the diagram) such that any download instruction (such as a pull-down screen for updating data) generated and displayed in the view 44 also corresponds to the current view 44 (i.e., the first timeline download instruction.)

Referring to FIG. 3, the first timeline and the second timeline coexist in an embodiment of the present invention, the view 44 shown on the screen corresponds to the view 44 of the second timeline (and thus the menu item 48 of the second timeline is highlighted in white in the diagram.) The view 44 displays a summary of a personal document message not pertaining to work. Referring to FIG. 3, the download instruction generated and displayed in the current view 44 is the second timeline download instruction. If the user selects the create new message button 50 in the view 44, the attribute of the message is automatically configured to correspond to the current view 44 (i.e., the second timeline shown in the diagram.)

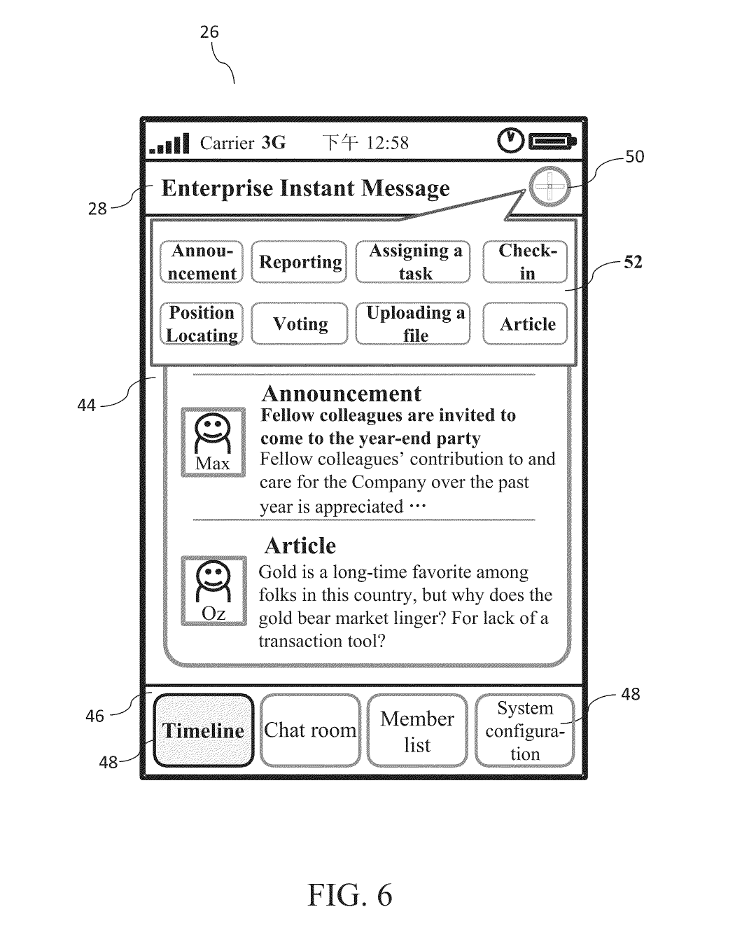

Referring to FIG. 4, in an embodiment of the present invention, the first timeline and the second timeline are merged (i.e., by configuring the timeline parameter to merge the first timeline and the second timeline), and the view 44 shown on the screen comprises a workplace document and a personal document message, wherein there is only one menu item 48 of timeline on the menu bar 46, and the menu item sequence generated by the first menu adjustment module 22 includes a timeline, a chat room, a member list, and a system configure. Referring to FIG. 4, the download instruction generated and displayed in the current view 44 is “merging timeline download instruction”. If the user selects the create new message button 50 in the view 44, the attribute of the message is configured either manually or automatically; in an embodiment of the present invention, the attribute of a message to be entered is selected to be “workplace documents” or “personal documents” (not shown) by the user with a pull-down menu or a radio button. In an embodiment of the present invention, the attribute is discerned by a function of the message (as shown in FIG. 6) and thus automatically configured.

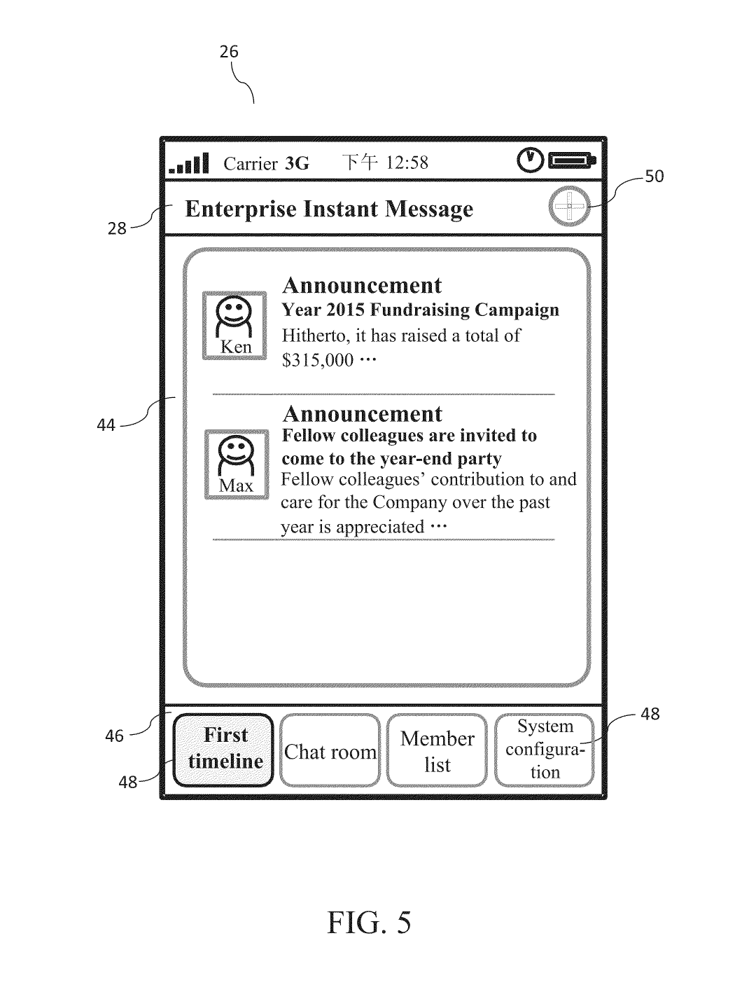

FIG. 5 shows that the first timeline and the second timeline coexist in an embodiment of the present invention, but the user of the account is not interested in any personal document messages not pertaining to work and thus takes the initiative in uploading the closing instruction (whereby the timeline parameter is configured to “close the second timeline”), and in consequence the menu item sequence generated by the first menu adjustment module 22 is as follows: the first timeline, a chat room, a member list, and system configuration. The user of the account can also take the initiative in uploading the switching on instruction for switching on the second timeline. Since the present invention is directed to distributing enterprise instant messages, the user is unable to close the first timeline related to workplace documents.

Referring to FIG. 6, in an embodiment of the present invention, after the user has selected the create new message button 50, a create new message category menu 52 is shown on the screen to allow the user to choose the type of a new message. In an embodiment of the present invention, the attributes are discerned by the functions, such as “announcement”, “reporting a case”, “assigning a task”, “check-in”, “position locating”, “voting”, “uploading a file”, and “article”, of the messages and thus automatically configured. In this regard, “announcement”, “reporting a case”, “assigning a task”, “check-in”, “position locating”, “voting”, and “uploading a file” are attributed to workplace document messages, whereas “article” is attributed to personal document messages. In an embodiment of the present invention, some of the functions listed on the create new message category menu 52 are attributed to the first timeline, whereas the other functions listed on the create new message category menu 52 are attributed to the second timeline, and in consequence the first message module of the server 10 writes a message to the first timeline or the second timeline of the database 24 in accordance with the attribute.

Referring to FIG. 6, in an embodiment of the present invention, after a merging timeline download instruction is uploaded, messages of the first and second timeline are merged and sent, and functions corresponding to the attribute are configured. Referring to FIG. 6, in another embodiment of the present invention, in the situation where messages related to one single timeline are displayed according to the prior art and sent to configure the functions corresponding to the attribute, the messages related to one single timeline can be displayed in accordance with the different functions of the attribute.

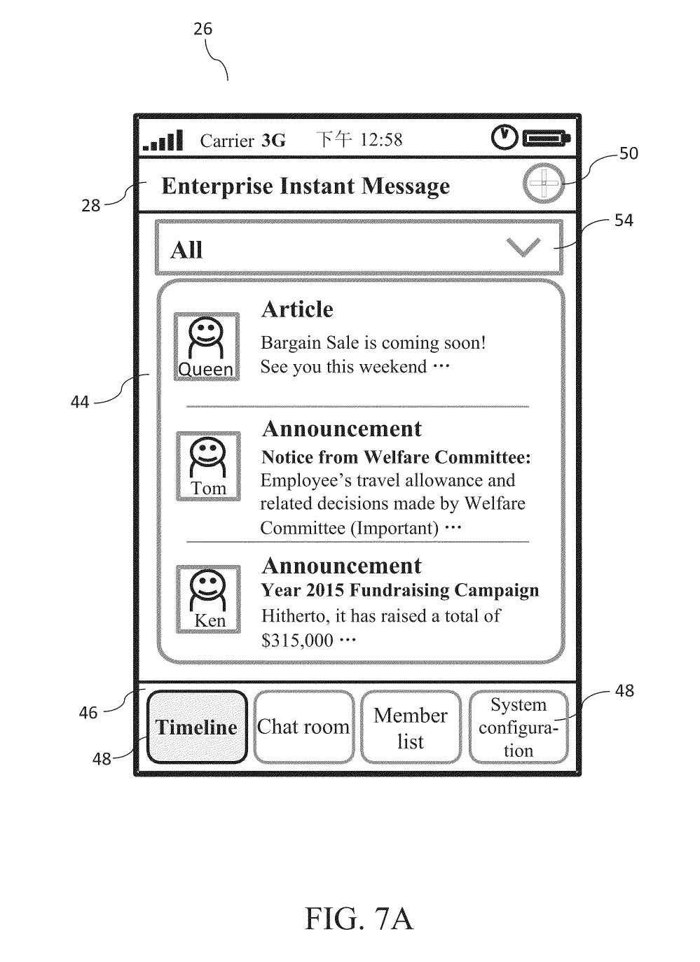

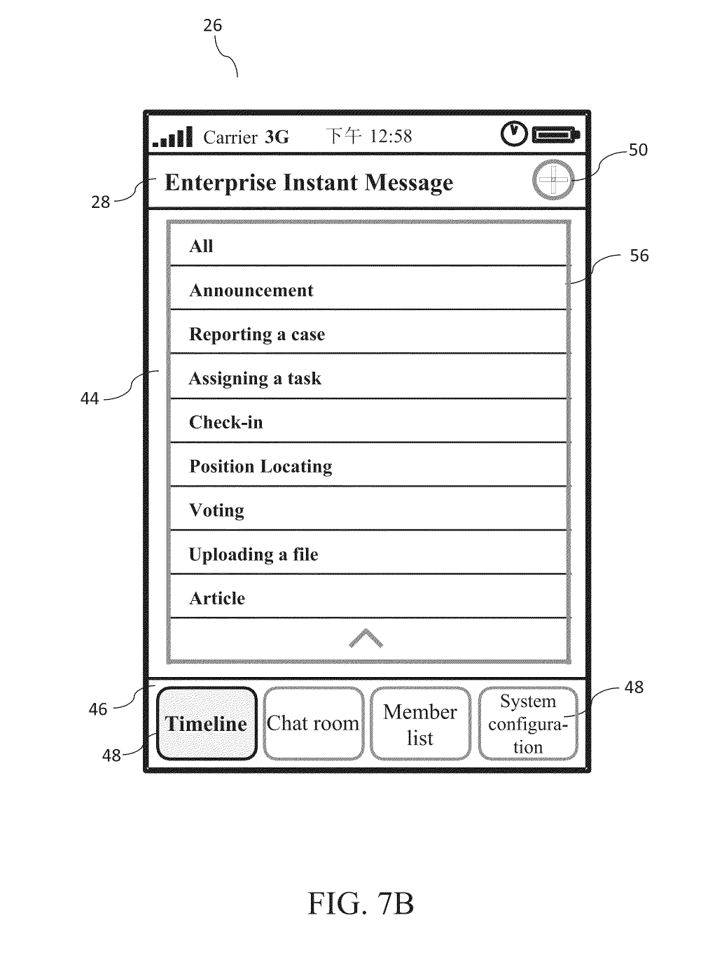

Referring to FIG. 7A, in another embodiment corresponding to the preceding embodiment illustrated with FIG. 6, the view 44 further displays a message category pull-down menu 54 (as shown in the diagram) whereby the user selects/filtrates an intended message category quickly. After selecting the message category pull-down menu 54, the user can unfold the menu (i.e., a downloaded message category menu 56) to display all message types. Referring to FIG. 7B, the user selects an intended message category so as to generate a download instruction corresponding to the intended message type, for example, selecting “announcement” to generate an announcement message download instruction.

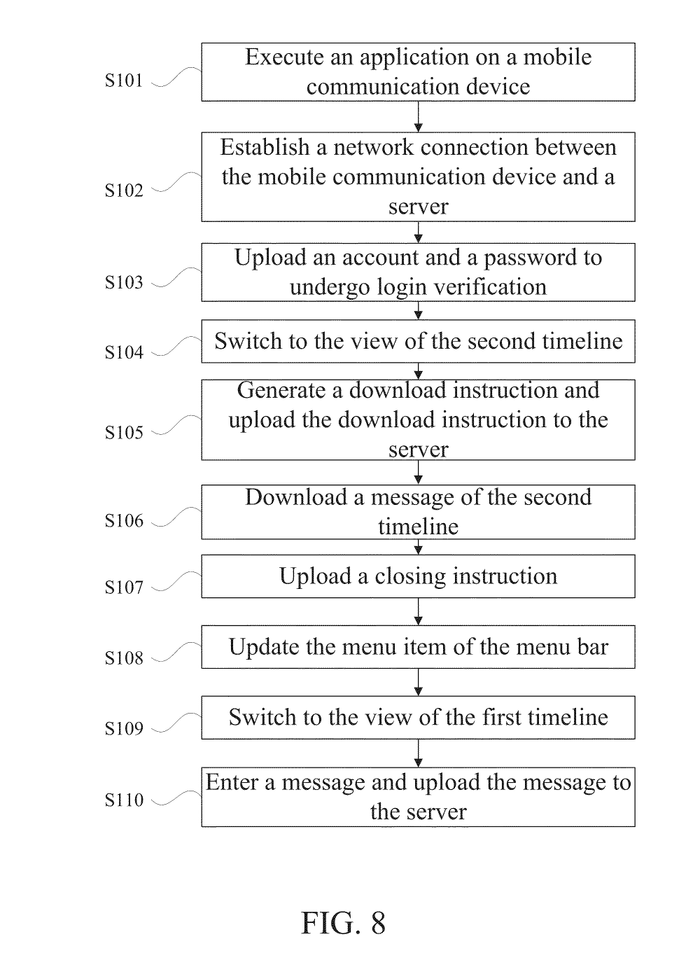

Referring to FIG. 8, there is shown a flowchart of a method according to an embodiment of the present invention. As shown in the diagram, the system is already configured by the administrator to two pieces of separate timeline dedicated to a private purpose and a public purpose, respectively. After logging in to the system, a member (i.e., user) follows the steps below successively: download a personal document message, upload the closing instruction, switch to a view of workplace document messages, and upload a new workplace document message. Referring to FIG. 1, FIG. 3 and FIG. 5, the process flow of the method of the present invention comprises the steps below.

Step S101: execute the application 28 on the mobile communication device 26. The mobile communication device 26 is exemplified by Apple's iPhone 6.

Step S102: establish a network connection between the mobile communication device 26 and the server 10. Upon execution of the application 28, a network connection is established between the second network communication module 30 of the application 28 and the first network communication module 12 of the server 10 of the cloud 42. The network connection complies with TCP protocol (including Socket and WebSocket connection), HTTP protocol or HTTPS (i.e., HTTP over SSL) protocol. The network connection of FIG. 8 complies with HTTP protocol or HTTPS protocol.

Step S103: upload an account and a password so as to undergo login verification. A member enters a first account and a first password with the application 28 of the mobile communication device 26. Then, the login module 32 uploads the account and the password entered by the member to the server 10 such that login verification is performed by the login verification module 14.

Step S104: switch to the view 44 of the second timeline. The user switches to the view 44 of the second timeline with the menu item 48 of the menu bar 46 as shown in FIG. 3.

Step S105: generate a download instruction and upload the download instruction to the server 10. When the network connection established in step S102 complies with HTTP protocol or HTTPS protocol, the data access module 34 generates the download instruction corresponding to the current view 44 as soon as the view 44 is switched, or generates the download instruction by the user's operation “pull-down screen” in the current view 44. In this embodiment, the current view 44 corresponds to the second timeline; hence, the download instruction thus generated is the second timeline download instruction, wherein, after being generated, the download instruction is uploaded to the server 10. When the network connection established in step S102 complies with Socket and WebSocket, the server 10 which has a new message does not require any download instruction which originates from the mobile communication device 26 and thus is capable of sending the new message directly to the mobile communication device 26.

Step S106: download a message of the second timeline. After the second timeline download instruction has been uploaded to the server 10 (when the network connection complies HTTP protocol or HTTPS protocol), the information filtering module 20 reads the message related to the second timeline from the database 24 to provide download. After the message has been downloaded, the second message module 38 displays a summary of the downloaded message in the view 44 of the screen such that the user can select the summary (by generating a selection instruction) to display the complete contents (not shown) of the message.

Step S107: upload a closing instruction. If the user no longer wants to read any personal document message, the user may upload the closing instruction from the system configuration (not shown) by menu operations. After the closing instruction has been uploaded to the server 10, the timeline management module 16 configures the timeline parameter to close the second timeline in accordance with the closing instruction.

Step S108: update the menu item 48 of the menu bar 46. After the configuration of the timeline parameter has changed, the first menu adjustment module 22 generates a new menu item sequence in accordance with the quantity of menu items displayed (say, four, in this embodiment) and the timeline parameter. In this embodiment, the updated menu item sequence is “the first timeline”, “chat room”, “member list”, and “system configure”. The second menu adjustment module 36 displays the menu item 48 on the menu bar 46 in accordance with the downloaded menu item sequence, as shown in FIG. 5.

Step S109: switch to the view 44 of the first timeline. In an embodiment of the present invention, if the user uploads the closing instruction to the view 44 of the second timeline initially, the screen automatically switches to the view 44 of the first timeline as soon as the view 44 of the second timeline is closed. If the current view 44 is initially directed to another function, such as “member list” (not shown), the user can directly select the menu item 48 related to the first timeline and displayed on the menu bar 46 in order to switch to the view 44 of the first timeline. FIG. 5 shows the current view after the switch.

Step S110: enter a message and upload the message to the server 10. In the situation where the current view 44 relates to the first timeline, the user enters a new workplace document message by selecting the create new message button 50 at the upper right corner of the current view 44. That is to say, the attribute of the message is automatically configured by the message entering module 40 according to the current view 44. In this embodiment, the attribute of a new message is configured to the first timeline to be uploaded to the server 10 as soon as the new message is entered, and then the new message is written to the first timeline of the database 24 by the first message module 18.

In various embodiments of the present invention, program instructions executed by a computer can implement every block in the flowchart, a combination of the blocks in the flowchart, and the steps in every embodiment. The program instructions are provided to a processor so as to be executed by the processor to thereby produce resources required for a machine or coordinated operation of hardware and software; hence, the instructions are executed on the processor to thereby produce elements required for carrying out actions specified by the blocks in the flowchart or technical effects. Different combinations of program instructions also allow simultaneous execution of at least some operating steps specified in the blocks in the flowchart, whereas the technical solutions indicated by the first through fourth program instructions of an application may vary from embodiment to embodiment. Furthermore, it is also practicable that some of the steps are executed on one or more processors, for example, in the case of a servo computer system of multiple processors or in the case of coordinated operation of a microprocessor in a mobile communication device and a peripheral interface processor. Moreover, in the flowchart, at least one block or a combination of blocks may be performed along with the other block or the other combination of blocks simultaneously or performed in a sequence different from its specified counterpart, without departing from the spirit and scope of the present invention.

Therefore, the blocks in the flowchart of the present invention support a combination of elements required for performing specified actions or technical solutions, a combination of steps required for performing specified actions or technical solutions, and program instruction elements required for performing specified actions or technical solutions. What is also understandable is that the specified actions or technical solutions are effectuated by a combination of blocks in the flowchart as well as each block in the flowchart of the present invention through the coordinated operation of a special-purpose hardware-style system or special-purpose hardware, and program instructions.

In conclusion, the present invention provides an enterprise instant message system and method applicable to a cloud and a mobile communication device for accessing the cloud so as to solve problems facing the prior art with a timeline management module whereby a company manages itself flexibly to serve a private purpose and a public purpose, wherein, when the company opts to manage workplace documents and personal documents with two separate pieces of timeline, respectively, a user can determine whether to close personal document messages not pertaining to work in order to focus on work and enhance work efficiency.

The technical solution of the present invention is disclosed above by preferred embodiments. However, the preferred embodiments are not restrictive of the present invention. Slight changes and modifications can be made by persons skilled in the art to the aforesaid embodiments without departing from the spirit of the present invention and shall still fall within the scope of the present invention. Accordingly, the legal protection for the present invention should be defined by the appended claims.

What is claimed is:

1. A system of an enterprise instant message, comprising:
a database for storing a first timeline, a second timeline, and a plurality of member information sets; and
a server for accessing the database, comprising:
a first network communication module for establishing a network connection with a mobile communication device associated with one of the member information sets;
a login verification module for verifying whether the mobile communication device connects with the server through a network;
a first message module for receiving at least one message uploaded by the mobile communication device and writing the message to one of the first timeline and the second timeline in accordance with an attribute, wherein the at least one message each comprises the attribute; and
an information filtering module for responding to a first timeline download instruction and reading the message related to the first timeline from the database to provide download, for responding to a second timeline download instruction and reading the message related to the second timeline from the database to provide download, for responding to a merging timeline download instruction and reading the message related to the first and second timeline from the database to provide download, and for automatically sending one of the message related to the first timeline and the message related to the second timeline to the mobile communication device,
wherein the database and the server together form a cloud.

2. The system of claim 1, wherein the server comprises a timeline management module for receiving a merging instruction or a separating instruction uploaded from a mobile communication device of an administrator to configure a timeline parameter, wherein the merging instruction configures the timeline parameter to merge the first timeline and the second timeline, and the separating instruction configures the timeline parameter to separate the first timeline and the second timeline.

3. The system of claim 2, wherein the timeline management module further receives one of a closing instruction and a switching on instruction uploaded from the mobile communication device associated with one of the member information sets to configure the timeline parameter.

4. The system of claim 3, wherein the closing instruction stops downloading the message of the second timeline, and the switching on instruction starts downloading the message of the second timeline.

5. The system of claim 1, wherein the server further comprises a first menu adjustment module for managing a plurality of menu items of a menu bar and generating a menu item sequence in accordance with quantity of menu items displayed and a timeline parameter.

6. The system of claim 1, wherein the mobile communication device comprises at least one processor and a screen, wherein the at least one processor executes a plurality of program instructions, the program instructions comprising:
a first program instruction for instructing the mobile communication device to establish a network connection with the server so as to undergo login verification;
a second program instruction for instructing the mobile communication device to upload the first timeline download instruction, the second timeline download instruction, and the merging timeline download instruction to the server and then download the related message from the server;
a third program instruction for instructing the mobile communication device to display a summary of the message in a view of the screen and receive a selection instruction of the summary to display complete contents of the message in the view; and
a fourth program instruction for instructing the mobile communication device to receive the message entered, configure the attribute of the message, and upload the message to the server.

7. The system of claim 6, wherein the program instructions further comprise a fifth program instruction for instructing the mobile communication device to display a plurality of menu items concerned on a menu bar in accordance with a menu item sequence downloaded from the server, with the menu bar displayed on the screen.

8. The system of claim 6, wherein the attribute of the message is configured manually.

9. The system of claim 6, wherein the attribute of the message is automatically configured in accordance with the current view.

10. The system of claim 6, wherein the attribute of the message is discerned by a function of the message and thus automatically configured.

11. The system of claim 1, wherein the attribute of the message is one of a first ID and a second ID, and the first message module writes the message to the first timeline in accordance with the attribute being the first ID and writes the message to the second timeline in accordance with the attribute being the second ID.

12. The system of claim 11, wherein the attribute of the message is one selected from a plurality of functions listed on a menu, wherein some of the functions are associated with the first ID, and the other functions are associated with the second ID.

13. The system of claim 1, wherein the attribute of the message is one of announcement, reporting a case, assigning a task, check-in, position locating, voting, uploading a file, and article.

14. A method of an enterprise instant message, applicable to a cloud comprising a database and a server, the method comprising the steps of:
storing a first timeline, a second timeline, and a plurality of member information sets in the database;
establishing a network connection between the server and a mobile communication device associated with one of the member information sets so as to undergo login verification;
receiving at least one message uploaded from the mobile communication device and writing the at least one message to one of the first timeline and the second timeline in accordance with an attribute by the server, the at least one message each comprising the attribute; and
responding to a first timeline download instruction and reading the message related to the first timeline from the database to provide download, responding to a second timeline download instruction and reading the message related to the second timeline from the database to provide download, responding to a merging timeline download instruction and reading the messages related to the first and second timeline from the database to provide download, respectively, and automatically sending the messages related to the first and second timeline to the mobile communication device, respectively, by the server.

15. The method of claim 14, further comprising the step of receiving by the server one of a merging instruction and a separating instruction uploaded from a mobile communication device of an administrator so as to configure a timeline parameter, wherein the merging instruction causes the timeline parameter to be configured to merge the first timeline and the second timeline and the separating instruction causes the timeline parameter to be configured to separate the first timeline and the second timeline.

16. The method of claim 15, further comprising the step of receiving by the server one of a closing instruction and a switching on instruction uploaded from the mobile communication device associated with one of the member information sets so as to configure the timeline parameter.

17. The method of claim 16, wherein the closing instruction causes the timeline parameter to be configured to close the second timeline, and the switching on instruction causes the timeline parameter to be configured to switch on the second timeline.

18. The method of claim 14, further comprising the step of managing a plurality of menu items of a menu bar and generating a menu item sequence in accordance with quantity of menu items displayed and a timeline parameter by the server.

19. The method of claim 14, wherein the mobile communication device associated with one of the member information sets comprises at least one processor and a screen, and the at least one processor executes a plurality of program instructions, the program instructions comprising:
a first program instruction for instructing the mobile communication device to receive the message entered, configure the attribute of the message, and upload the message to the server;
a second program instruction for instructing the mobile communication device to upload the first timeline download instruction, the second timeline download instruction, and the merging timeline download instruction to the server;
a third program instruction for instructing the mobile communication device to download from the server the message corresponding to one of the first timeline download instruction, the second timeline download instruction, and the merging timeline download instruction and display a summary of the message in a view of the screen; and
a fourth program instruction for instructing the mobile communication device to receive a selection instruction of the summary so as to display complete contents of the message in the view of the screen.

20. The method of claim 19, wherein the program instructions further comprise a fifth program instruction for instructing the mobile communication device to display a plurality of menu items concerned on a menu bar in accordance with a menu item sequence downloaded from the server, with the menu bar displayed on the screen.

21. The method of claim 19, wherein the attribute of the message is configured manually.

22. The method of claim 19, wherein the attribute of the message is automatically configured in accordance with the current view.

23. The method of claim 19, wherein the attribute of the message is discerned by a function of the message and thus automatically configured.

24. The method of claim 14, wherein the attribute of the message is one of a first ID and a second ID, and the server writes the message to the first timeline in accordance with the attribute being the first ID and writes the message to the second timeline in accordance with the attribute being the second ID.

25. The method of claim 24, wherein the attribute of the message is one selected from a plurality of functions listed on a menu, wherein some of the functions are associated with the first ID, and the other functions are associated with the second ID.

26. The method of claim 14, wherein the attribute of the message is one of announcement, reporting a case, assigning a task, check-in, position locating, voting, uploading a file, and article.

27. A method of an enterprise instant message, applicable to a cloud comprising a database and a server, and applicable to a mobile communication device for accessing a cloud, the cloud comprising a database and a server, the database storing therein a first timeline, a second timeline, and a plurality of member information sets, the mobile communication device being associated with one of the member information sets and comprising a screen, the method comprising the steps of:
establishing a network connection with the server so as to undergo login verification;
receiving a message entered, configuring an attribute of the message, and uploading the message to the server;
generating and uploading one of the first timeline download instruction, the second timeline download instruction, and the merging timeline download instruction in accordance with a view of the screen;
downloading the related message from the server and displaying a summary of the downloaded message in the view of the screen; and
receiving a selection instruction of the summary to display complete contents of the message in the view of the screen.

28. The method of claim 27, further comprising the step of displaying a plurality of menu items on a menu bar in accordance with a menu item sequence downloaded from the server, with the menu bar displayed on the screen.

29. The method of claim 27, wherein the attribute of the message is configured manually.

30. The method of claim 27, wherein the attribute of the message is automatically configured in accordance with the current view.

31. The method of claim 27, wherein the attribute of the message is discerned by a function of the message and thus automatically configured.

32. The method of claim 27, wherein the attribute of the message is one of a first ID and a second ID, and the server writes the message to the first timeline in accordance with the attribute being the first ID and writes the message to the second timeline in accordance with the attribute being the second ID.

33. The method of claim 32, wherein the attribute of the message is one selected from a plurality of functions listed on a menu, wherein some of the functions are associated with the first ID, and the other functions are associated with the second ID.

34. The method of claim 27, wherein the attribute of the message is one of announcement, reporting a case, assigning a task, check-in, position locating, voting, uploading a file, and article.

35. A system of an enterprise instant message, comprising:
a database for storing a timeline and a plurality of member information sets, the member information sets each comprising an account; and
a server for accessing the database, comprising:
a first network communication module for establishing a network connection with a mobile communication device associated with one of the member information sets;
a login verification module for verifying whether the mobile communication device logs in to the server with the account through a network and connects with the server through the network;
a first message module for receiving at least one message uploaded by the mobile communication device and writing the at least one message to the timeline of the database, wherein the at least one message each comprises an attribute; and
an information filtering module for responding to a timeline download instruction associated with the attribute, reading the message related to the timeline from the database, associated with the attribute, to provide download to the mobile communication device, and automatically sending to the mobile communication device the message related to the timeline and associated with the attribute,
wherein the database and the server together form a cloud.

36. The system of claim 35, wherein the attribute of the message is one selected from a plurality of functions listed on a menu, wherein some of the functions are associated with a first ID, and the other functions are associated with a second ID.

37. The system of claim 36, wherein the information filtering module responds to one of the first ID and the second ID and reads the message related to the timeline from the database to provide download to the mobile communication device.

38. The system of claim 35, wherein the attribute of the message is one of announcement, reporting a case, assigning a task, check-in, position locating, voting, uploading a file, and article.

39. A method of an enterprise instant message, applicable to a cloud comprising a database and a server, the method comprising the steps of:
storing timeline and a plurality of member information sets in the database, the member information sets each comprising an account;
establishing a network connection between the server and a mobile communication device associated with one of the member information sets to undergo login verification by the account;
receiving at least one message uploaded from the mobile communication device and writing the at least one message to the timeline by the server, the at least one message each comprising an attribute; and
responding to a timeline download instruction associated with the attribute, reading the message related to the timeline from the database, associated with the attribute, to provide download to the mobile communication device, and automatically sending the message related to the timeline and associated with the attribute to the mobile communication device, by the server.

40. The method of claim 39, wherein the attribute of the message is one of announcement, reporting a case, assigning a task, check-in, position locating, voting, uploading a file, and article.
